(19) United States
(12) Patent Application Publication
(10) Pub. No.: US 2012/0045012 A1
(43) Pub. Date: Feb. 23, 2012

(54) METHOD AND DEVICE FOR TRANSMITTING DATA IN A WIRELESS COMMUNICATION NETWORK

(75) Inventor: Pertti O. Alapuranen, Deltona, FL (US)

(73) Assignee: Motorola, Inc., Schaumburg, IL (US)

(21) Appl. No.: 12/239,703

(22) Filed: Sep. 26, 2008

(51) Int. Cl. H04L 27/00

(52) U.S. Cl. 375/295

(57) ABSTRACT

A method and device for transmitting data in a wireless communication network uses both cognitive frequency diversity and antenna diversity. The method includes identifying a bandwidth of one or more potentially interfering frequency sub-bands from one or more potentially interfering signals in a radio frequency (RF) band (step 605). Next, based on the bandwidth of the one or more potentially interfering frequency sub-bands, occupancy probabilities are calculated concerning whether the one or more potentially interfering frequency sub-bands will occupy each of a plurality of transmitting sub-bands in the RF band (step 610). Finally, the data are transmitted simultaneously over first and second transmitting sub-bands selected from the plurality of transmitting sub-bands based on the occupancy probabilities, where a first antenna transmits in the first transmitting sub-band and a second antenna transmits in the second transmitting sub-band (step 615).

### FIELD OF THE DISCLOSURE

The present invention relates generally to wireless communication networks, and in particular to reducing radio frequency (RF) interference.

### BACKGROUND

Unlicensed radio bands are currently used by numerous types of radio frequency (RF) communication devices, such as wireless local area network (WLAN) devices and cordless phones. In addition to communication signals, the unlicensed radio bands further include significant interference from equipment such as microwave ovens. Due to such interference, and the commercial success of unlicensed communication systems, many unlicensed radio bands, including industrial, scientific and medical (ISM) bands and unlicensed national information infrastructure (UNIT) bands, have become very congested.

The unlicensed radio bands include, among others, the bands from 5.725 to 5.875 GHz (Giga Hertz) (a UNIT band) and 2.4 to 2.48 GHz (an ISM band). The ISM band is commonly used by LAN devices such as, for example, Institute of Electrical and Electronics Engineers (IEEE) 802.11 devices and Bluetooth (registered trademark) devices. The UNII band is used by 802.11a LAN devices and for proprietary technologies. (For these and any IEEE standards recited herein, see: http://standards.ieee.org/getieee802/index.html or contact the IEEE at IEEE, 445 Hoes Lane, PO Box 1331, Piscataway, N.J. 08855-1331, USA.)

Wireless communication devices use various techniques to improve their noise tolerance and data rates when operating in unlicensed radio bands. For example, the use of forward error correction and multiple input multiple output (MIMO) techniques are often effective to overcome problems with interference and fading. However, such techniques are often ineffective in situations where interference is created from unpredictable, burst transmissions from other non co-operating systems.

Cognitive radio technology (CRT), as known by those having ordinary skill in the art, enables a wireless network device to dynamically adjust its transmitting or receiving parameters to avoid interference with other licensed or unlicensed RF sources. CRT devices observe the characteristics of their environment and then modify their operation so as to operate more efficiently under the observed circumstances. However, CRT devices are generally not successful at avoiding interference from random burst transmissions.

Adaptive antenna technologies are another common solution for interference management. These technologies are efficient in some circumstances, but can be complicated in mobile communication systems where a typical “null-steering” requires a large number of antenna elements to work together. Steering algorithms are often not able to efficiently handle random interference bursts from a large number of other network transmitters.

Accordingly, there is a need for an improved method and device for transmitting data in wireless communication networks while avoiding interference.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating a wireless communication network in which a wireless subscriber device and a wireless router are communicating over a defined RF bandwidth, according to some embodiments.

FIG. 2 is a frequency versus signal power graph illustrating a transmission from a subscriber device using cognitive frequency diversity and antenna diversity, according to some embodiments.

FIG. 3 is a diagram illustrating additional devices operating in a wireless communication network, according to some embodiments.

FIG. 4 is a frequency versus signal power graph illustrating a transmission from one device to another using cognitive frequency diversity and antenna diversity, according to some embodiments.

FIG. 5 is a block diagram illustrating components of a device for transmitting data in a wireless communication network using cognitive frequency diversity and antenna diversity, according to some embodiments.

FIG. 6 is a general flow diagram illustrating a method for transmitting data in a wireless communication network using cognitive frequency diversity and antenna diversity, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, a method enables reduced interference when transmitting data in a wireless communication network by using both cognitive frequency diversity and antenna diversity. The method includes identifying a bandwidth of one or more potentially interfering frequency sub-bands from one or more potentially interfering signals in a radio frequency (RF) band. Next, based on the bandwidth of the one or more potentially interfering frequency sub-bands, occupancy probabilities are calculated concerning whether the one or more potentially interfering frequency sub-bands will occupy each of a plurality of transmitting sub-bands in the RF band. Finally, the data are transmitted simultaneously over first and second transmitting sub-bands selected from the plurality of transmitting sub-bands based on the occupancy probabilities, where a first antenna transmits in the first transmitting sub-band and a second antenna transmits in the second transmitting sub-band.

Embodiments of the present invention thus enable a transmitting device to reduce interference by combining the benefits of space-time coding methods, cognitive radio technology (CRT), and antenna diversity techniques.

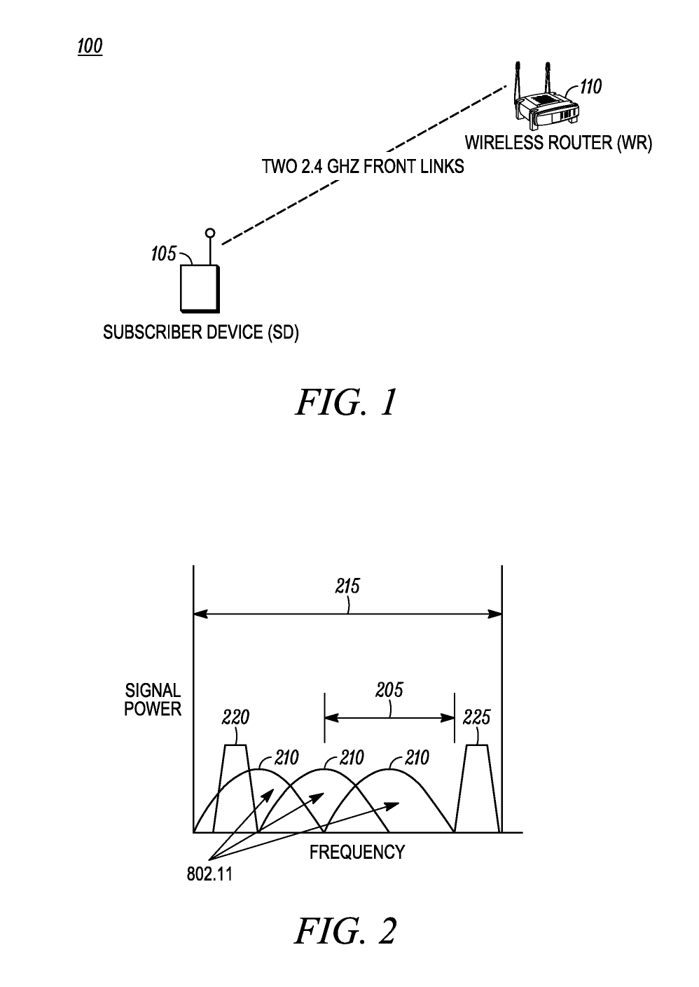

Referring to FIG. 1, a diagram illustrates a wireless communication network 100 in which a wireless subscriber device 105 and a wireless router 110 are communicating over a defined RF bandwidth, according to some embodiments of the present invention. Consider that the subscriber device 105 and the router 110 each employ two antennas, two transmitters and two receivers. Thus, for example, the two receivers at the subscriber device 105 can be tuned to different front link channels in the 2.4 GHz ISM band. A transmission from the subscriber device 105 then can be transmitted from a first antenna over a first channel, and the same transmission can be simultaneously transmitted from a second antenna over a second channel.

The wireless communication network 100 can comprise various types of network architectures including a mesh enabled architecture (MEA) network or an Institute of Electrical and Electronics Engineers (IEEE) 802.11 network (i.e. 802.11a, 802.11b, 802.11g, 802.11n). It will be appreciated by those of ordinary skill in the art that the wireless communication network 100 can alternatively comprise any packetized communication network where packets are forwarded across multiple wireless hops. For example, the wireless communication network 100 can be a network utilizing multiple access schemes such as OFDMA (orthogonal frequency division multiple access), TDMA (time division multiple access), FDMA (Frequency Division Multiple Access), or CSMA (Carrier Sense Multiple Access).

Referring to FIG. 2, a frequency versus signal power graph illustrates a transmission from the subscriber device 105 using cognitive frequency diversity and antenna diversity, according to some embodiments of the present invention. The subscriber device 105 first identifies a bandwidth 205 of three potentially interfering frequency sub-bands 210 in a radio frequency band 215. For example, the potentially interfering frequency sub-bands 210 may be defined by local unlicensed network devices transmitting using IEEE 802.11 protocols. The subscriber device 105 then calculates, based on the bandwidth 205 of the potentially interfering frequency sub-bands 210, occupancy probabilities that the sub-bands 210 will occupy each of a plurality of transmitting sub-bands in the radio frequency band 215. Data are then transmitted simultaneously over a first transmitting sub-band 220 from a first antenna and over a second transmitting sub-band 225 from a second antenna. However, the present invention is not limited to transmitting over only two antennas, as some embodiments may employ three or more antennas or multi-antenna arrays to transmit the data over the first and second transmitting sub-bands 220, 225.

Based on the occupancy probabilities, and based on the bandwidth 205 of the potentially interfering frequency sub-bands 210, the first transmitting sub-band 220 has a low probability of simultaneous occupancy relative to the second transmitting sub-band 225. That means it is very unlikely that a signal in one of the potentially interfering frequency sub-bands 210 could interfere with the transmissions in both the first transmitting sub-band 220 and the second transmitting sub-band 225. As used herein, the term cognitive frequency diversity refers to the use of cognitive radio technology (CRT) to estimate parameters of potentially interfering signals, such as in the potentially interfering frequency sub-bands 210, and then define separated frequency sub-bands, such as the transmitting sub-bands 220, 225, that are likely to avoid simultaneous interference from the potentially interfering signals.

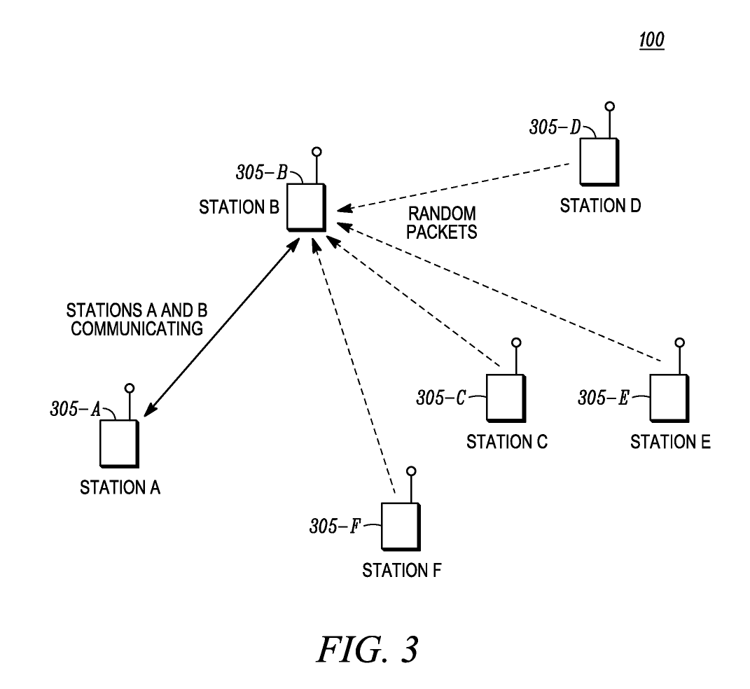

Referring to FIG. 3, a diagram illustrates additional devices operating in the wireless communication network 100, according to some embodiments of the present invention. Consider for example that a device 305-A at a station A is communicating with another device 305-B at a station B. Further, consider that various additional potentially interfering devices 305-C, 305-D, 305-E, and 305-F are also operating in the network 100 and are transmitting data packets that are randomly received at the device 305-B. Such random data packets thus create potentially interfering signals at the device 305-B.

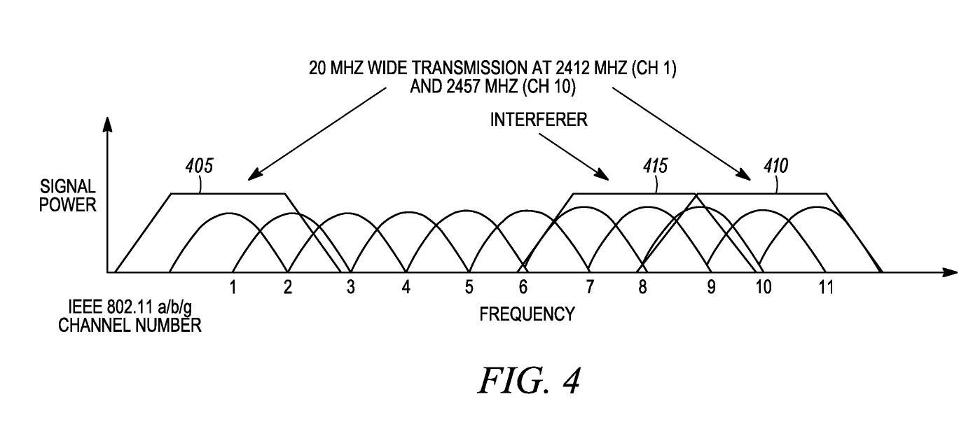

Referring to FIG. 4, a frequency versus signal power graph illustrates a transmission from the device 305-B to the device 305-A using cognitive frequency diversity and antenna diversity, according to some embodiments of the present invention. Consider that the device 305-B transmits a first 20 Mega Hertz (MHz) wide signal 405 centered at 2412 MHz (corresponding to IEEE 802.11a/b/g channel 1) and a second 20 MHz wide signal 410 centered at 2457 MHZ (corresponding to IEEE 802.11a/b/g channel 10). Further consider that the potentially interfering devices 305-C, 305-D, 305-E, and 305-F are transmitting random data packets on one of the eleven defined IEEE 802.11a/b/g channels, where each interfering transmission, such as an interfering signal 415, also occupies a 20 MHz bandwidth.

Because the gap between the center frequencies of the first signal 405 and the second signal 410 is greater than 20 MHz, the probability that the interfering signal 415 can interfere with both the first signal 405 and the second signal 410 is zero. Further, occupancy probabilities that one of the potentially interfering devices 305-C, 305-D, 305-E, and 305-F will randomly select one of the eleven defined IEEE 802.11a/b/g channels can be computed using basic statistics.

For example, the device 305-B may transmit over IEEE 802.11a/b/g channels 1, 6 and 11. The device 305-B may select a first transmitting sub-band for the first signal 405 that corresponds to a channel that is least occupied, and then select a second transmitting sub-band for the second signal 410 that corresponds to a channel that is separated from the first transmitting sub-band by more than an average bandwidth of potentially interfering signals.

The simultaneous transmission of the first signal 405 and the second signal 410 may, for example, result in an estimated loss in signal to noise ratio (SNR) of 3 decibels (dB) when compared with a single 20 MHz transmission from the device 305-B. However, performance degradation due to similar actual reductions in SNR can be overcome by significant gains in throughput achieved by the present invention due to the avoidance of interference.

Various methods that are known by those having ordinary skill in the art can be used to select first and second transmitting sub-bands in which, respectively, the first signal 405 and the second signal 410 are transmitted. For example, maximal ratio combiner (MRC) and selection diversity combiner (SDC) techniques may be used. Also, strategies for using different combiner techniques can be created dynamically based on real-time analysis of properties of interfering signals, such as the length of interfering signals.

Calculating occupancy probabilities can be based on occupancy statistics of potentially interfering signals in a band of interest as measured by a device, such as the device 305-B, immediately before selecting first and second transmitting sub-bands. The device 305-B can measure an occupied bandwidth of potentially interfering signals and use transmitting sub-bands that have a frequency separation that is, for example, larger than an average bandwidth of potentially interfering signals, or that is larger than a largest measured bandwidth of a potentially interfering signal. A typical frequency separation for devices transmitting in ISM bands can be 22 MHz, considering that interference from IEEE 802.11a/b/g devices operating in these bands will likely use a bandwidth of 20 MHz. In other circumstances, a frequency separation of 40 MHz may be required due to wide band transmissions. After occupancy probabilities and transmitting sub-bands are determined, a device can also share data concerning the occupancy probabilities and transmitting sub-bands with other network devices to enable the other devices to also improve throughput by reducing interference. For example, after a network device calculates occupancy probabilities and selects appropriate transmitting sub-bands, data that identify the occupancy probabilities and/or an identification of the transmitting sub-bands can be transmitted to neighboring network nodes that can immediately begin using the occupancy probabilities and/or the transmitting sub-bands to improve the throughput of the neighboring network nodes.

Further, as known by those having ordinary skill in the art, various cognitive frequency diversity techniques can be used to observe potentially interfering traffic and identify a bandwidth of one or more potentially interfering frequency sub-bands. Such techniques include those described in US Patent Application Publication US 2007/0086396 A1, published on Apr. 19, 2007, titled “System and Method for Performing Distributed Signal Classification for a Multi-Hop Cognitive Communication Device”, the entire contents of which are hereby incorporated by reference in their entirety herein.

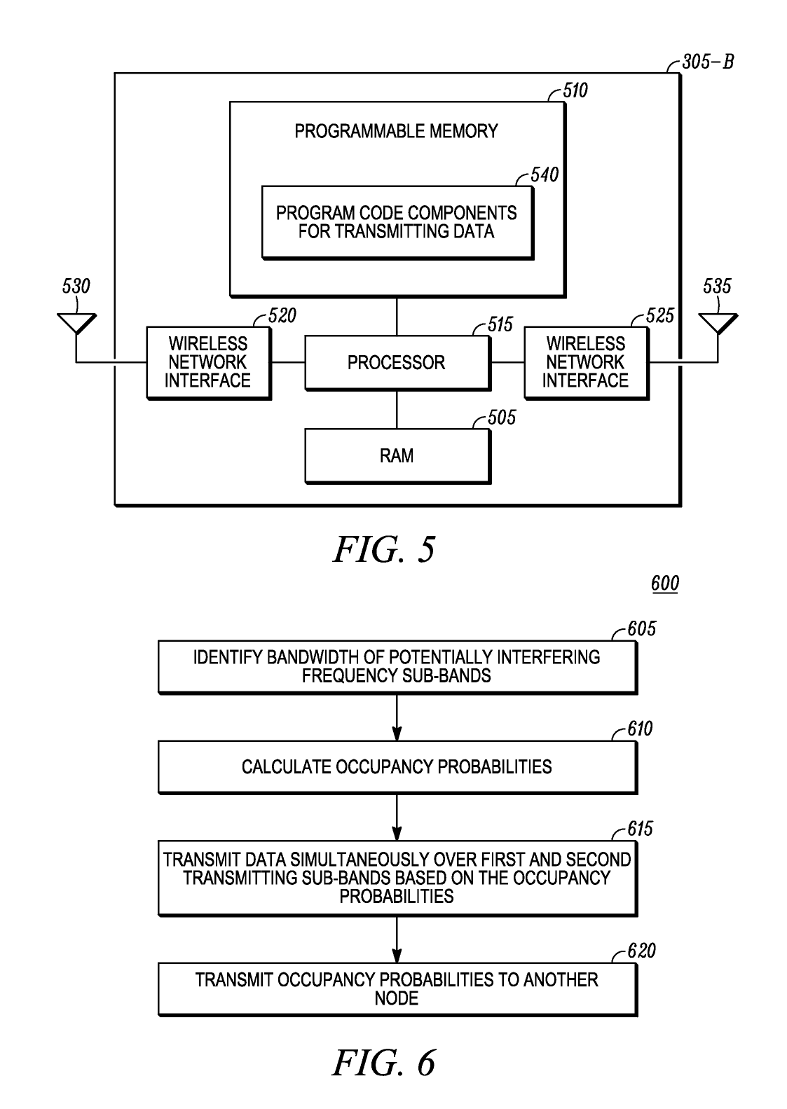

Referring to FIG. 5, a block diagram illustrates components of a device for transmitting data in a wireless communication network using cognitive frequency diversity and antenna diversity, such as the device 305-B, according to some embodiments. The device 305-B, for example, can be an integrated unit containing at least all the elements depicted in FIG. 5, as well as any other elements necessary for the Device 305-B to perform its particular functions. Alternatively, the Device 305-B can comprise a collection of appropriately interconnected units or devices, wherein such units or devices perform functions that are equivalent to the functions performed by the elements depicted in FIG. 5.

The device 305-B comprises a random access memory (RAM) 505 and a programmable memory 510 that are coupled to a processor 515. The processor 515 also has ports for coupling to wireless network interfaces 520, 525. The wireless network interfaces 520, 525 can be used to enable the device 305-B to communicate with other node devices in a wireless communication network, such as in the wireless communication network 100. Antenna diversity, as described herein, can be achieved by simultaneously using a first antenna 530 and a second antenna 535. For example, the device 305-B can transmit to the device 305-A simultaneous and identical packets using both of the wireless network interfaces 520, 525 and, respectively, the first and second antennas 530, 535. It will be appreciated by those of ordinary skill in the art that two wireless network interfaces are shown for illustrative purposes only herein, and that any number of wireless network interfaces can be implemented within the scope of the invention.

The programmable memory 510 can store operating code (OC) for the processor 515 and code for performing functions associated with a network device. For example, the programmable memory 510 can store computer readable program code components 540 configured to cause execution of a method for transmitting data in a wireless communication network using cognitive frequency diversity and antenna diversity as described herein.

Referring to FIG. 6, a general flow diagram illustrates a method 600 for transmitting data in a wireless communication network using cognitive frequency diversity and antenna diversity, according to some embodiments of the present invention. First, at step 605, a device identifies a bandwidth of one or more potentially interfering frequency sub-bands from one or more potentially interfering signals in a radio frequency band. For example, the device 305-B identifies a bandwidth of 20 MHz of one or more potentially interfering IEEE 802.11a/b/g signals transmitted in the 2.4 GHz ISM band by one or more of the potentially interfering devices 305-C, 305-D, 305-E, and 305-F operating in the wireless communication network 100.

At step 610, the device calculates, based on the bandwidth of the one or more potentially interfering frequency sub-bands, occupancy probabilities that the one or more potentially interfering frequency sub-bands will occupy each of a plurality of transmitting sub-bands in the radio frequency band. For example, the device 305-B may calculate occupancy probabilities for three transmitting sub-bands, which correspond to IEEE 802.11a/b/g channels 1, 6 and 10.

At step 615, the device transmits the data simultaneously over first and second transmitting sub-bands selected from the plurality of transmitting sub-bands based on the occupancy probabilities, wherein a first antenna transmits in the first transmitting sub-band and a second antenna transmits in the second transmitting sub-band. For example, the device 305-B may transmit data in the form of the signal 405 using a first transmitting sub-band corresponding to IEEE 802.11a/b/g channel 1, and simultaneously transmit the data in the form of the signal 410 using a second transmitting sub-band corresponding to IEEE 802.11a/b/g channel 10. The signal 405 can be transmitted from the antenna 530, and the signal 410 can be transmitted simultaneously from the antenna 535.

At step 620, the device transmits to another node in the wireless communication network data that identify the occupancy probabilities. For example, the device 305-B may transmit the occupancy probabilities to the device 305-A to enable the device 305-A to determine its own appropriate transmitting sub-bands.

Advantages of some embodiments of the present invention therefore include enabling a higher throughput from wireless devices based on interference avoidance. By combining cognitive frequency diversity and antenna diversity, a more efficient solution is provided for managing random interference bursts from multiple sources.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element preceded by “comprises a . . . ”, “has a . . . ”, “includes a . . . ”, or “contains a . . . ” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for transmitting data in a wireless communication network using cognitive frequency diversity and antenna diversity, the method comprising:
identifying a bandwidth of one or more potentially interfering frequency sub-bands from one or more potentially interfering signals in a radio frequency band;
calculating, based on the bandwidth of the one or more potentially interfering frequency sub-bands, occupancy probabilities that the one or more potentially interfering frequency sub-bands will occupy each of a plurality of transmitting sub-bands in the radio frequency band; and
transmitting the data simultaneously over first and second transmitting sub-bands selected from the plurality of transmitting sub-bands based on the occupancy probabilities, wherein a first antenna transmits in the first transmitting sub-band and a second antenna transmits in the second transmitting sub-band.

2. The method of claim 1, further comprising transmitting to another node in the wireless communication network data that identify the occupancy probabilities.

3. The method of claim 1, wherein the first transmitting sub-band defines, based on the occupancy probabilities, a least occupied sub-band.

4. The method of claim 3, wherein the second transmitting sub-band defines, based on the occupancy probabilities, a second least occupied sub-band that is separated from the first transmitting sub-band by at least the identified bandwidth of the one or more potentially interfering frequency sub-bands.

5. The method of claim 1, wherein the identified bandwidth is a most common bandwidth in the one or more potentially interfering frequency sub-bands.

6. The method of claim 1, wherein selection diversity combiner (SDC) techniques are used to select at least one of the first and second transmitting sub-bands.

7. The method of claim 1, wherein the radio frequency band comprises a 2.4 GHz ISM band.

8. The method of claim 1, wherein the potentially interfering frequency sub-bands define IEEE 802.11 channels.

9. The method of claim 1, wherein one or more of the potentially interfering frequency sub-bands has a bandwidth of 20 MHz.

10. A device for transmitting data in a wireless communication network using cognitive frequency diversity and antenna diversity, comprising:
computer readable program code components for identifying a bandwidth of one or more potentially interfering frequency sub-bands from one or more potentially interfering signals in a radio frequency band;
computer readable program code components for calculating, based on the bandwidth of the one or more potentially interfering frequency sub-bands, occupancy probabilities that the one or more potentially interfering frequency sub-bands will occupy each of a plurality of transmitting sub-bands in the radio frequency band; and
computer readable program code components for transmitting the data simultaneously over first and second transmitting sub-bands selected from the plurality of transmitting sub-bands based on the occupancy probabilities, wherein a first antenna transmits in the first transmitting sub-band and a second antenna transmits in the second transmitting sub-band.

11. The device of claim 10, further comprising computer readable program code components for transmitting to another node in the wireless communication network data that identify the first occupancy probabilities.

12. The device of claim 10, wherein the first transmitting sub-band defines, based on the occupancy probabilities, a least occupied sub-band.

13. The device of claim 12, wherein the second transmitting sub-band defines, based on the occupancy probabilities, a second least occupied sub-band that is separated from the first transmitting sub-band by at least the identified bandwidth of the one or more potentially interfering frequency sub-bands.

14. The device of claim 10, wherein the identified bandwidth is a most common bandwidth in the one or more potentially interfering frequency sub-bands.

15. The device of claim 10, wherein selection diversity combiner (SDC) techniques are used to select the data in one of the sub-bands.

16. The device of claim 10, wherein the radio frequency band comprises a 2.4 GHz ISM band.

17. The device of claim 10, wherein the potentially interfering frequency sub-bands define IEEE 802.11 channels.

18. The device of claim 10, wherein one or more of the potentially interfering frequency sub-bands has a bandwidth of 20 MHz.

19. A device for transmitting data in a wireless communication network using cognitive frequency diversity and antenna diversity, comprising:
means for identifying a bandwidth of one or more potentially interfering frequency sub-bands from one or more potentially interfering signals in a radio frequency band;
means for calculating, based on the bandwidth of the one or more potentially interfering frequency sub-bands, occupancy probabilities that the one or more potentially interfering frequency sub-bands will occupy each of a plurality of transmitting sub-bands in the radio frequency band; and
means for transmitting the data simultaneously over first and second transmitting sub-bands selected from the plurality of transmitting sub-bands based on the occupancy probabilities, wherein a first antenna transmits in the first transmitting sub-band and a second antenna transmits in the second transmitting sub-band.
